(19) United States
(12) Patent Application Publication
(10) Pub. No.: US 2013/0284031 A1
(43) Pub. Date: Oct. 31, 2013

(54) COOKING DEVICE FOR THE VACUUM COOKING METHOD

(71) Applicant: Bernd Braukmann, Arnsberg (DE)

(72) Inventor: Bernd Braukmann, Arnsberg (DE)

(21) Appl. No.: 13/823,892

(22) PCT Filed: Sep. 13, 2011
(86) PCT No.: PCT/EP11/04584

§ 371 Date: Jul. 3, 2013

(30) Foreign Application Priority Data
Sep. 17, 2010 (DE) 20 2010 012 775.0

(51) Int. Cl. A47J 36/16

(52) U.S. Cl. CPC A47J 36/16
USPC 99/343; 99/352

(57) ABSTRACT

A device for optimally preparing food according to the sous-vide method using a device for preparing food according to the sous-vide method (vacuum cooking method), wherein the food is surrounded by a vacuum bag. A heating element surrounds the vacuum bag of the cooking product and is designed as a heating foil or cover or as a heating gel.

The invention is directed at an apparatus for preparation of foods according to the “sous vide” method (vacuum cooking technique), whereby the foods are enclosed by a vacuum bag.

Usually, foods are prepared for human consumption by means of various methods, for example by cooking, roasting, or boiling, for which ovens, microwaves, steam cookers, and the like are available as preparation devices. These devices have a defined cooking space, whereby these cooking spaces limit the size of the accommodation containers for the foods to be prepared to the interior dimensions of the space.

In food preparation using “sous vide” cooking, the foods, including the spices, are introduced into vacuum bags, and, after the air has been removed from the bag, the bags are held at cooking temperature in a water bath (bain marie) over a specific period of time.

In connection with all cooking methods, certain disadvantages are accepted. For example, the available cooking space is frequently not coordinated with the size of the food to be cooked, so that a relatively large amount of energy is wasted. Regulation of the temperature is frequently not precise enough or extremely complicated, whereby simple boiling in water is accompanied by a loss in vitamins. In the case of cooking in hot air, the surface of the food to be cooked oxidizes. Here, too, vitamins, pigments, and aromas are lost.

Frequently, these preparation methods also involve complicated cleaning of the corresponding devices.

This is where the invention takes its start; its task consists in making available an apparatus for optimal preparation of foods according to the “sous vide” method.

This task is accomplished, according to the invention, with an apparatus of the type indicated initially, by means of a heating element that encloses the vacuum bag of the food to be cooked, whereby the heating element is configured as a heating foil or heating cover or as a heating gel.

Enclosing a vacuum bag containing the corresponding food to be cooked by means of a heating foil has a great number of advantages, because it encloses the vacuum bag with shape fit.

Very uniform cooking can be performed at minimal energy expenditure. In addition, the space required is small, operation and control of temperature are reliable and simple, the area of use is flexible, and cleaning is extremely simple.

Embodiments of the invention are evident from the dependent claims. In this connection, it can be provided that the heating element is additionally enclosed by an insulation body. In the case of such an insulation body, a heat insulation pocket or a heat insulation bag can in turn be provided, with the advantages described above for the heating foil itself.

According to the invention, the heating foil is equipped with its own temperature regulator and/or a timer, whereby in further embodiments according to the invention, a thermometer that measures the core temperature in the food to be cooked can also be provided.

If a heating gel is used for heating the vacuum bag of the food to be cooked, the invention provides that this heating gel is accommodated in its own sheath. This sheath can be structured in such a manner that it can be closed after hermetical enclosure of the bag for the food to be cooked.

Because a vacuum cooking device is available in the production of the bags of food to be cooked, this can also be used to remove any air spaces that might still be present between the bag of the food to be cooked and the heating gel bag, on the other hand. For this purpose, the invention provides, in a further embodiment, that a valve to the air space between heating foil and heating gel, on the one hand, and the bag of the food to be cooked, on the other hand, for removal of residual air, is provided.

Of course, as already in the case of the heating foil, a temperature regulator and a timer, or a thermometer that measures the core temperature, is provided, individually or as a whole in the case of the heating gel.

Further characteristics, details, and advantages of the invention are evident from the following description and on the basis of the drawing. This shows, in

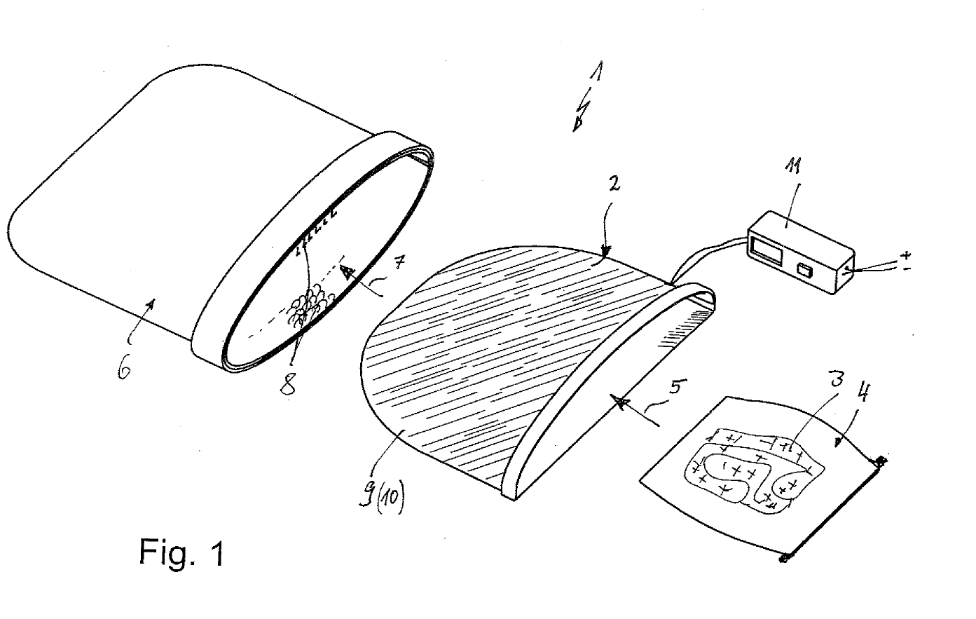

FIG. 1 a simplified exploded representation of the apparatus according to the invention, and in

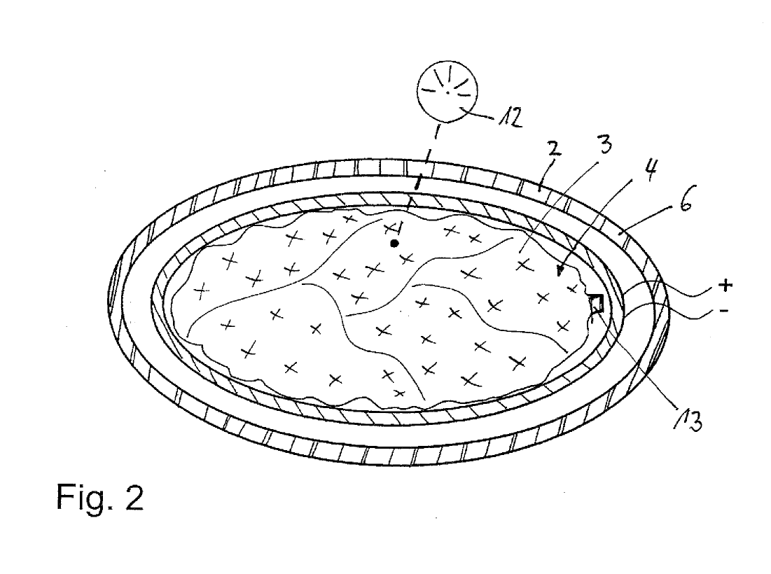

FIGS. 2 to 4 sectional representations through the apparatus according to the invention, in different embodiments.

The apparatus according to the invention, designated in general with 1, is formed by an essentially elastic heating element 2 for heating food 3 to be cooked in a vacuum bag 4. In the position of use, i.e. in the preparation of foods, the vacuum bag 4 is placed in the heating element 2, as indicated by an arrow 5 in FIG. 1. The heating element 2 is then pushed into an insulation body 6, which is indicated by an arrow 7, whereby subsequently, the insulation body is closed by means of a hook and loop closure 8, for example. The heating element 2 can be structured as a heating foil or a heating cover, or can also be formed by a heating gel, whereby in the following, the heating foil is designated with 9 and heating gel with 10.

The heating element, for example the heating foil 9, is connected with a temperature regulator 11. This element 11 can also comprise a timer, in addition.

In the sectional drawings, which are shown in simplified form, the individual elements in turn are shown in greatly simplified form.

In FIG. 2, a thermometer 12 for measuring the core temperature of the food to be cooked is also indicated symbolically. The connections for drawing off the air, in each instance, are in turn only indicated symbolically, and designated as 13 on the bag for the cooked food. The electrical connections are designated only symbolically with “+/−”.

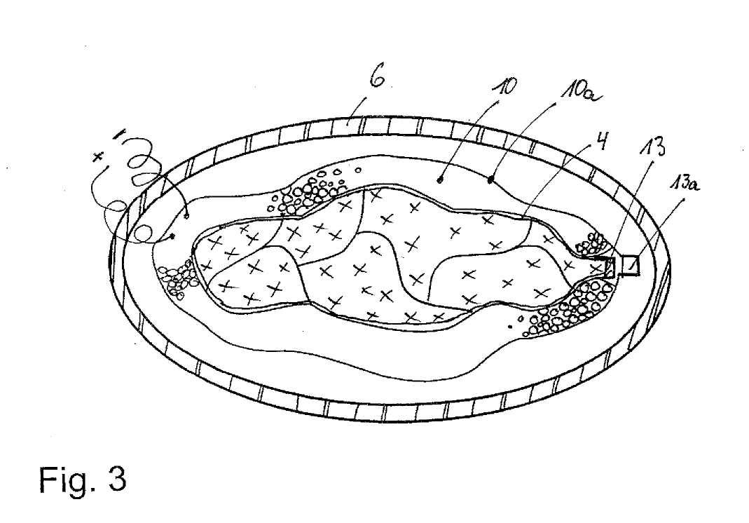

In FIG. 3, a variant is shown with a heating gel 10 that encloses the food to be cooked, in a corresponding bag 10a. This bag 10a that accommodates the heating gel can be structured in such a manner that it is also equipped with a valve 13a or a comparable element, in order to connect a vacuum source there, so that this can draw off the residual air between the vacuum bag 4, on the one hand, and the bag 10a that encloses the heating gel, on the other hand.

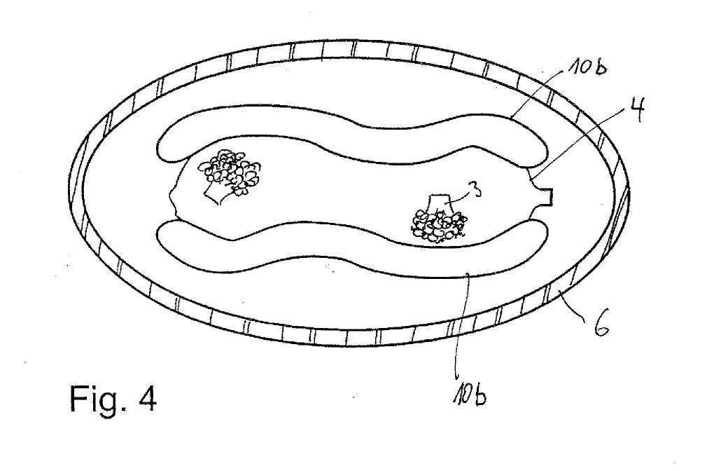

In FIG. 4, a variant is shown in such a manner that two flat bags 10b, for example, with heating gel, enclose the food 3 to be cooked, in the vacuum bag 4.

Of course, the exemplary embodiments of the invention as described can still be modified in many different ways, without departing from the basic idea. Thus, the invention is not restricted to the special configuration and the layout of the heating foil or of the heating cover 9 shown, also not to the configuration of the accommodation bags 10a for the heating gel 10; also, the connections for the vacuum source, in each instance, can be structured differently from what is shown; this also holds true for the configuration of the insulation body that encloses the heating foil. Of course, cooking can take place according to the invention even in bags that are not vacuum bags, if the air is pressed out of the bag and the bag has been tightly sealed, for example in a freezer bag.

1. Apparatus (1) for preparation of foods according to the “sous vide” method (vacuum cooking technique), wherein the foods are enclosed by a vacuum bag, comprising a heating element (2) that encloses the vacuum bag (4) of the food (3) to be cooked, wherein the heating element (2) is configured as a heating foil or cover (9) or as a heating gel (10).

2. Apparatus according to claim 1, wherein the heating element (2) is enclosed by an insulation body (6).

3. Apparatus according to claim 1, wherein the heating foil (9) is equipped with a temperature regulator (11).

4. Apparatus according to claim 1, wherein the heating foil (9) is equipped with a timer.

5. Apparatus according to claim 1, comprising a thermometer (12) that measures the core temperature in the food to be cooked.

6. Apparatus according to claim 1, wherein the heating gel (10) is accommodated in a sheath (10a).

7. Apparatus according to claim 1, wherein the sheath (10a) of the heating gel can be hermetically sealed after the bag (4) of the food to be cooked has been introduced.

8. Apparatus according to claim 7, wherein a valve (13a) to the air space between heating foil (9) or heating gel (10), on the one hand, and the vacuum bag (4) of the food to be cooked, on the other hand, for removal of residual air, is provided.
